(19) United States
(12) Patent Application Publication
(10) Pub. No.: US 2016/0036158 A1
(43) Pub. Date: Feb. 4, 2016

(54) RESIN MOLDED PRODUCT AND WATERPROOF SHIELDED CONNECTOR

(71) Applicant: Yazaki Corporation, Tokyo (JP)

(72) Inventors: Hideomi ADACHI, Kosai-shi (JP); Yoshiaki OZAKI, Kosai-shi (JP)

(73) Assignee: YAZAKI CORPORATION, Tokyo (JP)

(21) Appl. No.: 14/881,508

(22) Filed: Oct. 13, 2015

Related U.S. Application Data
(63) Continuation of application No. PCT/JP2013/061695, filed on Apr. 15, 2013.

(51) Int. Cl. H01R 13/52; H01R 13/6581

(52) U.S. Cl. CPC H01R 13/5202; H01R 13/6581

(57) ABSTRACT

The invention is directed to a resin molded product including: a resin molded product body part; and a seal part, serving as a seal structure portion with a fixation target, which is integrated with the resin molded product body part, wherein a resin material for forming the resin molded product is a polyphenylene sulfide resin, and a waterproof shielded connector including: a connector housing which is the resin molded product; a terminal fitting which is provided in a terminal of an electrically conducting path; and a shield shell which is provided on an outer side of the connector housing and fixed so as to press the connector housing onto a fixation target.

### CROSS REFERENCE TO RELATED APPLICATIONS

This application is a continuation of PCT application No. PCT/JP2013/061695, which was filed on Apr. 15, 2013, the contents of which are incorporated herein by reference.

### BACKGROUND OF THE INVENTION

1. Field of the Invention

The present invention relates to a resin molded product and a waterproof shielded connector including the resin molded product.

2. Description of the Related Art

A motor, an inverter, a high-voltage battery, etc. are mounted on a hybrid automobile or an electric automobile. A high-voltage wire harness is used for electrically connecting these devices with one another. The high-voltage wire harness is arranged to include high-voltage electric cables which serve as electrically conducting paths, an electromagnetic shield member which is conductive and which covers and shields the high-voltage electric cables, and a waterproof shielded connector which serves as an electrically connecting portion for the devices. The waterproof shielded connector is provided in terminal portions of the high-voltage electric cables.

The waterproof shielded connector is arranged to include conductive terminal fittings which are provided on the terminals of the high-voltage electric cables respectively, an insulating connector housing which has terminal reception chambers for storing the terminal fittings respectively, a conductive shield shell which is provided on an outer side of the connector housing, a shield ring which swages and fixes a terminal of the electromagnetic shield member to a predetermined position of the shield shell, and an area seal packing which is provided for waterproof.

The area seal packing is pressed onto a shield case when the shield shell is fixed to a device. Thus, the device can be sealed off. The area seal packing is formed into an annular shape so that the area seal packing can be inserted into an annular groove of the connector housing terminal. The area seal packing and the annular groove are provided as seal structure parts for preventing moisture or the like from invading.

### SUMMARY OF THE INVENTION

According to the waterproof shielded connector in the related art, for example, JP-A-2010-244976, there is a fear that the area seal packing may drop out from the annular groove of the connector housing when the area seal packing is formed into a simple annular shape and the annular groove is formed into a simple annular groove shape. As a solution thereto, it can be considered that a dropout prevention structure is added to the area seal packing and the annular groove. However, when the dropout prevention structure is added, there is a problem that the structure of the area seal packing and the annular groove becomes complicated.

In addition, the aforementioned waterproof shielded connector in the background art consists of a large number of constituent parts, for example, requiring work for inserting the area seal packing into the annular groove. Therefore, there is a problem that it takes time and labor to assemble the waterproof shielded connector.

The invention is accomplished in consideration of the aforementioned circumstances. An object of the invention is to provide a resin molded product capable of preventing dropout in a seal structure portion and improving workability, and a waterproof shielded connector including the resin molded product.

To achieve the previously described object, the resin molded products and the waterproof shielded connector of the present invention are characterized in the following (1) to (3).

(1) A resin molded product including: a resin molded product body part; and a seal part, serving as a seal structure portion with a fixation target, which is integrated with the resin molded product body part, wherein a resin material for forming the resin molded product is a polyphenylene sulfide (PPS) resin.

(2) The resin molded product of (1), wherein: the seal part is formed as a portion of an annular area seal; and the resin molded product body part is formed as a connector housing body.

(3) A waterproof shielded connector including: a connector housing which is the resin molded product of (1) or (2); a terminal fitting which is provided in a terminal of an electrically conducting path; and a shield shell which is provided on an outer side of the connector housing and fixed so as to press the connector housing onto a fixation target.

According to the invention stated in the above-recited (1), polyphenylene sulfide (PPS) resin is used as the resin material for use in resin molding. Thus, there is an effect that a resin molded product having a structure in which the seal part is integrated with the resin molded product body part can be provided. According to the invention, due to the integration, the seal part can be prevented from dropping out, and the work of attaching the seal part is not required. Thus, there is an effect that dropout in the seal structure portion can be prevented and the workability can be improved. In addition, according to the invention, due to the structure in which the seal part is integrated with the resin molded product body part, the number of parts can be reduced in comparison with that in the background art. In combination of the effect of improving the workability, there is also an effect that the cost can be reduced satisfactorily.

According to the invention stated in the above-recited (2), there is an effect that the connector housing in which the portion of the annular area seal is integrated with the connector housing body can be provided as a resin molded product.

According to the invention stated in the above-recited (3), in terms of the configuration, the waterproof shielded connector includes the resin molded product of the above-recited (1) or (2) as a connector housing. Thus, there is an effect that dropout in the seal structure portion can be prevented and the workability can be improved. In addition, there is an effect that the cost can be reduced satisfactorily. According to the invention, there is an effect that the waterproof shielded connector can be provided as a seal-member-less (packingless) waterproof shielded connector.

### BRIEF DESCRIPTION OF THE DRAWINGS

FIGS. 1A and 1B are Schematic views relating to the invention, and FIG. 1A is a perspective view of a resin molded product, and FIG. 1B is a side view of the resin molded product which has been disposed between fixation targets (Example 1).

FIG. 2 is a perspective view of a connector housing (Example 2).

FIG. 3 is a perspective view of a waterproof shielded connector (Example 3).

### DETAILED DESCRIPTION OF THE EXEMPLARY EMBODIMENTS

A resin molded product as a whole is molded out of polyphenylene sulfide (PPS) resin in such a manner that a seal part is integrated with a resin molded product body part. When the resin molded product body part is a connector housing body, the resin molded product serves as a connector housing in which the portion of an annular area seal is integrated with the connector housing body. A waterproof shielded connector including such a connector housing in the configuration is useful.

### Example 1

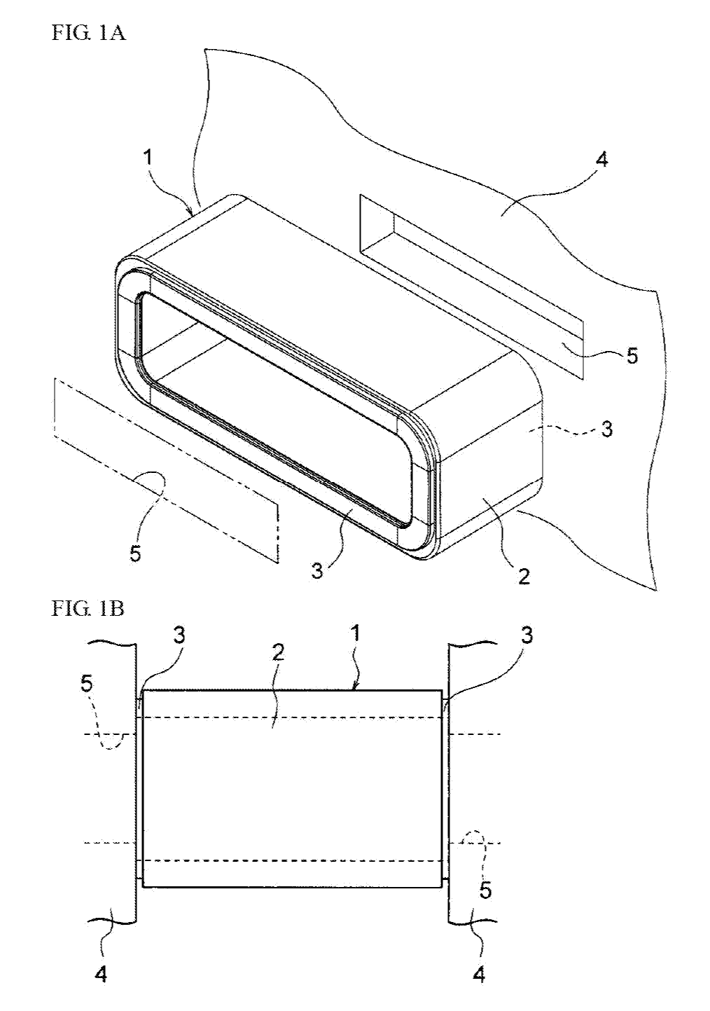

Example 1 will be described below with reference to the drawings. FIGS. 1A and 1B are schematic views relating to the invention. FIG. 1A is a perspective view of a resin molded product, and FIG. 1B is a side view of the resin molded product which has been disposed between fixation targets.

In FIGS. 1A and 1B, the reference sign 1 represents a resin molded product. The resin molded product 1 consists of a single part, which is, as a whole, molded out of polyphenylene sulfide (PPS) resin. Although not limited particularly, the resin molded product 1 is formed into a cylindrical shape in this Example. Such a resin molded product 1 includes a cylindrical resin molded product body part 2, and a seal part 3 which is molded integrally with each terminal of the resin molded product body part 2. The seal part 3 is a seal structure portion for a fixation target 4 which is, for example, formed like a wall. The seal part 3 is formed in the portion of an annular area seal around a hole 5 penetrating the fixation target 4. Since the seal part 3 serves as the portion of the area seal, the seal part 3 is formed so that the seal part 3 can make tight contact with a flat surface. When the seal part 3 is pressed onto the periphery of the hole 5 and brought into tight contact therewith, moisture or oil can be prevented from invading from the outside.

The seal part 3 is not a seal member provided as a separate part but a portion which is molded integrally with each terminal of the resin molded product body part 2. The seal part 3 molded integrally serves as a seal structure portion because the resin material used therein is a polyphenylene sulfide (PPS) resin. The polyphenylene sulfide (PPS) resin is a useful resin material which can have both rigidity required as the resin molded product body part 2 and a seal property required as the seal part 3. The polyphenylene sulfide (PPS) resin is a resin material superior in heat resistance and oil resistance.

For various resin parts mounted in automobiles, examples of resin materials used therein may include acrylic resin, ABS (acrylonitrile-butadiene-styrene copolymer)-based resin, PC (polycarbonate)-based resin, PVC (polyvinyl chloride)-based resin, olefin-based resin such as polyethylene or polypropylene, PEI (polyetherimide)-based resin, PBT (polybutylene terephthalate)-based resin, PPS (polyphenylene sulfide)-based resin, alloy of ABS/vinyl chloride, alloy of acrylic/vinyl chloride, polyester elastomer, block copolymer of PBT and polyether, etc. Polyphenylene sulfide (PPS) resin is the most suitable resin material to mold the seal part 3 integrally with each terminal of the resin molded product body part 2 in the state where the seal part 3 serves as a seal structure portion. Polyphenylene sulfide (PPS) resin is used (used in Examples 1 to 3).

It is also effective that a slight amount of a rubber material is mixed and used in polyphenylene sulfide (PPS) resin.

As described above with reference to FIGS. 1A and 1B, the resin molded product 1 has a structure in which the seal part 3 serving as a seal structure portion for the fixation target 4 is integrated with each terminal of the resin molded product body part 2. Therefore, it is a matter of course that the seal part 3 does not drop out and the work of attaching the seal part 3 is not required. As a result, there is an effect that dropout in the seal structure portion can be prevented and the workability can be improved. In addition, due to the structure in which the seal part 3 is integrated with each terminal of the resin molded product body part 2, the number of parts can be reduced in comparison with that in the background art. In combination of the aforementioned effect of improving the workability, there is also an effect that the cost can be reduced satisfactorily.

### Example 2

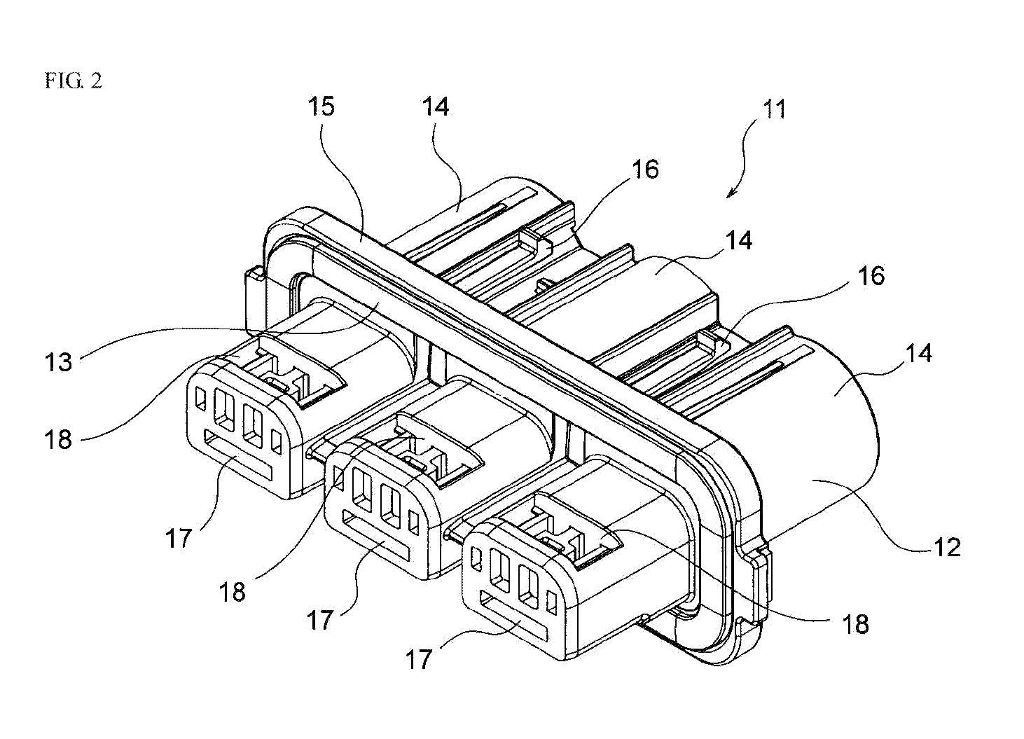

Example 2 will be described below with reference to the drawing. FIG. 2 is a perspective view of a connector housing.

In FIG. 2, the reference sign 11 represents a connector housing which is a resin molded product. The connector housing 11 consists of a single part, which is, as a whole, molded out of polyphenylene sulfide (PPS) resin. The connector housing 11 has a connector housing body 12 (resin molded product body part), and a seal part 13 which is molded integrally with the connector housing body 12.

The connector housing body 12 has three terminal reception parts 14 and an annular flange part 15 in this Example. The three terminal reception parts 14 are disposed to be arrayed laterally, and lock arms 16 having flexibility are formed in portions where the terminal reception parts 14 are linked with one another. An opening as a terminal insertion portion is formed at the rear end of each terminal reception part 14. In addition, the front end thereof has an opening part 17 which is open in a rectangular shape corresponding to a protrusion portion of an electric contact part in a not-shown terminal fitting. The inner portion of each terminal reception part 14 serves as a reception portion for a terminal of the aforementioned terminal fitting or a terminal of a not-shown electrically conducting path, and is formed into a hollow shape. The reference sign 18 in each terminal reception part 14 represents a fitting part for a not-shown terminal lock member.

The flange part 15 is disposed and formed to be located between the lock arms 16 and the fitting parts 18. The flange part 15 is formed as an annular flange portion surrounding the array of the three terminal reception parts 14. The rear end side of such a flange part 15 is mainly formed as a portion supporting a not-shown shield shell. The shield shell is supported by the flange part 15 and locked by the lock arms 16.

The seal part 13 is a portion serving as a seal structure portion in the same manner as in Example 1. The seal part 13 is molded integrally with the front end of the flange part 15. The seal part 13 is formed in the portion of an annular area seal. Since the seal part 13 serves as the portion of the area seal, the seal part 13 is formed so that the seal part 3 can make tight contact with a flat surface. When the seal part 13 is pressed and brought into tight contact, moisture or oil can be prevented from invading from the outside.

The seal part 13 is not a seal member provided as a separate part but a portion which is molded integrally with the connector housing body 12. The seal part 13 molded integrally serves as a seal structure portion because the resin material used therein is a polyphenylene sulfide (PPS) resin in the same manner as in Example 1.

As described above with reference to FIG. 2, the connector housing 11 has a structure in which the seal part 13 serving as a seal structure portion is integrated with the connector housing body 12. Therefore, it is a matter of course that the seal part 13 does not drop out and the work of attaching the seal part 13 is not required. As a result, there is an effect that dropout in the seal structure portion can be prevented and the workability can be improved. In addition, due to the structure in which the seal part 13 is integrated with the connector housing body 12, the number of parts can be reduced in comparison with that in the background art. In combination of the aforementioned effect of improving the workability, there is also an effect that the cost can be reduced satisfactorily.

### Example 3

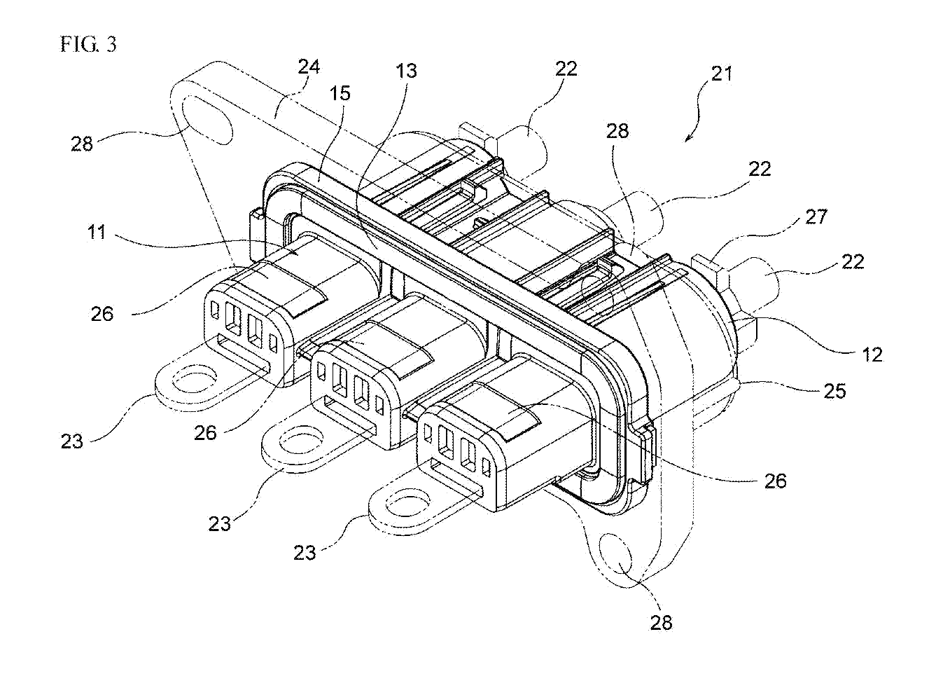

Example 3 will be described below with reference to the drawing. FIG. 3 is a perspective view of a waterproof shielded connector.

In FIG. 3, the reference sign 21 represents a waterproof shielded connector which is provided in a terminal of a not-shown high-voltage wire harness. The waterproof shielded connector 21 is connected and fixed to a not-shown device (fixation target) such as an inverter. The waterproof shielded connector 21 has a waterproof structure capable of preventing moisture or oil from invading the inside of the device from the connected/fixed portion.

The waterproof shielded connector 21 is arranged to include a connector housing 11 which is made of PPS as described in Example 2, conductive terminal fittings 23 which are provided in terminals of three high-voltage electric cables 22 (electrically conducting paths) respectively, a conductive shield shell 24 which is supported and locked on the outer side of the connector housing 11, a shield ring 25 which fixes a terminal of a not-shown electromagnetic shield member, terminal lock members 26 which are fitted into the connector housing 11 so as to lock the terminal fittings 23, and a rear holder 27 which is fitted to the rear end of the connector housing 11.

The shield shell 24 is formed so that the shield shell 24 can press the seal part 13 of the connector housing 11 onto a not-shown device (fixation target). A plurality of fixation parts 28 for bolting are formed in the shield shell 24.

As described above with reference to FIG. 3, the waterproof shield connector 21 has the connector housing 11 in the configuration. Therefore, there is an effect that dropout in the seal structure portion can be prevented and the workability can be improved. In addition, there is an effect that the cost can be reduced satisfactorily.

Besides, it is a matter of course that various changes can be made on the invention without departing from the gist of the invention.

What is claimed is:

1. A resin molded product comprising:
a resin molded product body part; and
a seal part, serving as a seal structure portion with a fixation target, which is integrated with the resin molded product body part,
wherein a resin material for forming the resin molded product is a polyphenylene sulfide resin.

2. The resin molded product according to claim 1, wherein the seal part is formed as a portion of an annular area seal, and the resin molded product body part is formed as a connector housing body.

3. A waterproof shielded connector comprising:
a connector housing which is the resin molded product according to claim 1;
a terminal fitting which is provided in a terminal of an electrically conducting path; and
a shield shell which is provided on an outer side of the connector housing and fixed so as to press the connector housing onto a fixation target.
